(19) United States
(12) Patent Application Publication
(10) Pub. No.: US 2014/0220434 A1
(43) Pub. Date: Aug. 7, 2014

(54) NICKEL IRON BATTERY EMPLOYING A COATED IRON ELECTRODE

(71) Applicant: Encell Technology, Inc., Alachua, FL (US)

(72) Inventor: Randy Gene OGG, Newberry, FL (US)

(73) Assignee: Encell technology, Inc., Alachua, FL (US)

(21) Appl. No.: 14/169,499

(22) Filed: Jan. 31, 2014

Related U.S. Application Data
(60) Provisional application No. 61/759,777, filed on Feb. 1, 2013.
(60) Provisional application No. 61/898,238, filed on Oct. 31, 2013.

(51) Int. Cl. H01M 4/24; H01M 4/52; H01M 4/62; H01M 4/38

(52) U.S. Cl. CPC H01M 4/248; H01M 4/38; H01M 4/521; H01M 4/622; H01M 2004/021
USPC 429/211

(57) ABSTRACT

Provided is a Ni—Fe battery comprising a high quality, high performance iron electrode. In one embodiment the iron electrode comprises a polyvinyl alcohol binder. The iron electrode of the Ni—Fe battery comprises a single conductive substrate coated on one or both sides with an iron active material.

### CROSS REFERENCE TO RELATED APPLICATIONS

This application claims priority to U.S. Provisional Application Ser. No. 61/759,777, filed Feb. 1, 2013; and U.S. Provisional Application Ser. No. 61/898,238, filed Oct. 31, 2013, which applications are incorporated herein by reference in their entirety.

### BACKGROUND OF THE INVENTION

1. Field of the Invention

The present invention is in the technical field of energy storage devices. More particularly, the present invention is in the technical field of rechargeable batteries employing an iron electrode.

2. State of the Art

The nickel iron (Ni—Fe) battery was independently developed by Edison in the United States and by Junger in Sweden in 1901. It was industrially important from its introduction until the 1970's when batteries with superior specific energy and energy density replaced Ni—Fe batteries in many applications.

However, Ni—Fe batteries have many advantages over other battery chemistries. The Ni—Fe battery is a very robust battery which is very tolerant of abuse such as overcharge and overdischarge and can have a very long life. It is often used in backup situations where it can be continuously trickle-charged and last more than 20 years. Additionally, the iron active material is much less expensive than active materials used in other alkaline battery systems such as NiMH or in non-aqueous batteries such as Li Ion. However, the low specific energy, low energy density, and poor power have limited the applications of this battery system.

The Ni—Fe battery is a rechargeable battery having a nickel(III) oxy-hydroxide positive electrode and an iron negative electrode, with an alkaline electrolyte such as potassium hydroxide. The overall cell reaction can be written as:

2 NiOOH+Fe+2H₂O [symbol] 2 Ni(OH)₂+Fe(OH)₂ (1)

The ability of these batteries to survive frequent cycling is due to the low solubility of the reactants in the electrolyte. The formation of metallic iron during charge is slow due to the low solubility of the reaction product ferrous hydroxide. While the slow formation of iron crystals preserves the electrodes, it also limits the high rate performance. Ni—Fe cells are typically charged galvanostatically and should not be charged from a constant voltage supply since they can be damaged by thermal runaway. Thermal runaway occurs due to a drop in cell voltage as gassing begins due to overcharge, raising the cell temperature, increasing current draw from a constant potential source, further increasing the gassing rate and temperature.

As shown in Equation (1), the overall cell reaction does not involve the battery electrolyte; however, alkaline conditions are required for the individual electrode reactions. Therefore, iron-based batteries such as Ni—Fe, Fe-air, and Fe—MnO₂ batteries all employ a strong alkaline electrolyte typically of KOH, typically in the range of 30-32% KOH. KOH is typically employed due to its lower cost, higher conductivity, and low freezing point. LiOH may be added in cells subject to high temperatures due to its stabilization effects on the nickel electrode, improving its charge acceptance at elevated temperatures.

It is known in the art that the addition of sulfur or sulfides can be added to the iron electrode active mass to inhibit the passivation of the electrode (D. Linden and T. Reddy, Editors, “Handbook of Batteries, Third Edition”, McGraw-Hill, © 2002). Sulfur and/or sulfide addition changes the electrocrystallization kinetics and makes the iron electrode reaction more reversible. Sulfide also is known to absorb on the iron electrode, raising the overpotential for the hydrogen evolution reaction during charging. A disadvantage of the prior art associated with adding sulfur or sulfides to the iron active mass is loss of sulfide over time due to dissolution of sulfide into the electrolyte and resultant oxidation to sulfate, which is ineffective in providing lasting activation of the iron electrode.

The addition of sulfide additives to alkaline electrolyte is similarly known in the art. Particularly, the addition of sulfur content is described in Swedish Pat. No 196,168 which recommends sulfide concentrations on the order of 0.03 to 0.1% of the iron active mass. It has further been suggested by others that if the local sulfide concentration is too high, the activating effect is actually reversed due to blockage of the active mass. Hence, U.S. Pat. No. 4,250,236A teaches the use of sparingly soluble sulfide compounds whose solubility is at most 10⁻² moles per liter. These inventors claim that higher concentrations of sulfide in the electrolyte does not result in substantial prolongation of the life time of the electrode due to oxidation of sulfide to sulfate, which may precipitate and block pores of the electrode. In fact, they claim that concentrations in excess of 10⁻² moles per liter is detrimental to battery performance and life.

Traditionally, the iron electrode active material is produced by dissolving pure iron powder in sulfuric acid, followed by drying and roasting to produce iron oxide (Fe₂O₃). The material is washed and partially reduced in hydrogen and partially oxidized to give a mix of Fe and magnetite (Fe₃O₄). The negative electrode structure is typically that of a pocket plate construction wherein the active material is introduced into the current collector. The current collector is made up of steel strips or ribbons that are perforated and nickel plated and the strip formed into a tube or pocket with one end left open for introduction of the active material (D. Linden and T. Reddy, Editors, “Handbook of Batteries, Third Edition”, McGraw-Hill, © 2002).

An alternative process utilizes a porous sintered structure of iron powder, which provides a conductive structure for the active material. This porous plaque is filled with iron hydroxide by either an electrochemical process or by impregnation of the pores with an appropriate iron salt, followed by immersion in alkaline solution. Such electrodes suffer from poor active material loading and corrosion of the iron porous plaque during impregnation, leading to limited life. To achieve sufficient loadings of active material, multiple impregnation cycles are required, adding to cost. Impurities resulting from the impregnation process must be removed by repeated washings to eliminate degradation of cell performance such as high rates of self-discharge.

To address these short-comings, U.S. Pat. No. 4,236,927 describes a process whereby iron powder and a reducible iron compound are mixed together and sintered into a stable body. This mixture is then sintered at high temperature to form a plate of desired shape. While this eliminates the need for a sintered plaque substrate or pockets of Ni-coated steel, it requires high temperature sintering under hydrogen atmosphere. Such processes add considerable complexity and cost in volume manufacturing.

All of these methods for producing iron electrodes are expensive, lead to low active material utilization, and poor specific energy. As a result, Ni—Fe batteries have largely been displaced by other battery technologies due to the high cost of manufacturing and low specific energy. While the technology of preparing iron electrodes is well known and the current preferred process for making these electrodes is a pocket design, pocket design electrodes are not cost effective and are complex in manufacturing. Although the theoretical capacity of an iron electrode is high, in practice only a small percentage of this is achieved due to the poor conductivity of iron oxide. In a pocket electrode design, loss of contact to the external matrix surface results in increased polarization and a drop in cell voltage. To avoid this, large amounts of conductive material such as graphite must be added to the active material, further increasing cost and lowering energy density.

Other forms of electrode production are known in the general rechargeable battery art, particularly electrodes of a pasted construction. This type of electrode typically incorporates a binder with the active material, which can then be coated onto a two or three dimensional current collector, dried, and compacted to form the finished electrode.

U.S. Pat. No. 3,853,624 describes a Ni—Fe battery incorporating iron electrodes employing a metal fiber structure which is loaded with sulfurized magnetic iron oxide by a wet pasting method. The plates are electrochemically formed outside the cell to electrochemically attach the iron active material to the plaque structure. Such a process is unwieldy in high volume manufacturing and adds to product cost.

U.S. Pat. No. 4,021,911 describes an iron electrode wherein the iron active mass is spread onto a grid and rolled and dried. The electrode is then treated with an epoxide resin solution to form a solid reinforcing film-like layer on the electrode surface. However, it can be expected that such a surface film would contribute to an insulating nature to the electrode surface, significantly increasing charge transfer resistance and lowering the cell's ability to sustain high charge and/or discharge rates.

Similarly, PTFE has been proposed as a binder system for paste type electrodes for alkaline batteries. U.S. Pat. No. 3,630,781 describes the use of a PTFE aqueous suspension as a binder system for rechargeable battery electrodes. However, to maintain the PTFE powder in suspension, it is necessary to add surfactants to the suspension, which must be removed from the resultant electrode by extensive washing, adding cost and complexity to the manufacturing process. An alternative approach for a PTFE-bonded electrode is described in U.S. Pat. No. 4,216,045 using fluorocarbon resin powder to form a sheet which can be attached to a conductive body. However, the use of PTFE results in a water-repellent surface, which while beneficial in a recombinant battery such as NiCd or NiMH, is detrimental to the performance of a flooded Fe—Ni battery where good contact between the electrode and electrolyte is beneficial.

Pasted electrodes using various binders have been proposed for alkaline electrodes, most particularly for electrodes employing hydrogen-absorbing alloys for NiMH batteries (for example U.S. Pat. No. 5,780,184). However, the desired properties for these electrodes differ significantly from those desired for a high capacity iron electrode. In the case of the MH electrode, high electrode density (low porosity) is required to maintain good electrical contact between the alloy particles and to facilitate solid-state hydrogen diffusion in the alloy. By contrast, high porosity is desirable for iron electrodes due to the low solubility of the iron oxide species. Hence, binder systems developed for other types of alkaline electrodes have not been optimized for Ni—Fe batteries and hence have not found commercial application.

One object of the present invention is to provide a Ni—Fe battery with improved performance over current art. The industry would be well served by an improved Ni—Fe battery, particularly with improved economics, which would enable Ni—Fe batteries to be used in expanded applications.

### SUMMARY OF THE INVENTION

The present invention provides one with a battery having an iron anode, e.g., a Ni—Fe battery, having low cost, ease of manufacture, and improved performance characteristics. The battery employs an iron electrode that comprises a single conductive substrate coated on one or both sides with iron active material. The iron active material may contain additives to improve activation and performance. The electrolyte is an aqueous alkaline solution such as 30% KOH. Alternatively, the battery may use an electrolyte comprising NaOH, LiOH, and Na₂S. The iron electrode is coupled with a suitable positive electrode, e.g., a nickel oxyhydroxide electrode. In one embodiment, a polyolefin separator is employed to provide electrical separation between the plates. The result is a low-cost battery of enhanced power, capacity and efficiency that is adaptable to mass production methods. Cycle life is improved relative to prior art.

Among other factors, it has been discovered that the incorporation into a Ni—Fe battery of a coated iron electrode comprising an iron active material coated on one or both sides of a single conductive substrate provides improved performance and lower cost than conventional Ni—Fe batteries. By offering lower cost, ease-of manufacture, improved energy and power densities, such a Ni—Fe battery can be employed in multiple applications where current Ni—Fe battery performance and cost precludes their usage.

### BRIEF DESCRIPTION OF THE FIGURES OF THE DRAWING

FIG. 1 is a perspective view of a coated iron electrode.

FIG. 2 is a side view and cross-section view of an iron electrode coated on both sides of the substrate.

FIG. 3 is a perspective view of a current pocket iron electrode.

FIG. 4 is a schematic of a battery in accordance with one embodiment of the present invention.

FIG. 5 is discharge capacities for Ni—Fe cells with iron electrodes having varied binder compositions.

FIG. 6 is discharge capacities for Ni—Fe cells with iron electrodes having varied nickel and iron content.

FIG. 7 is discharge capacities for Ni—Fe cells with iron electrodes having varied sulfur content.

### DETAILED DESCRIPTION OF THE INVENTION

The invention comprises an improved Ni—Fe battery employing an iron electrode comprised of a single conductive substrate coated with iron active material on one or both sides. In one embodiment, the iron electrode is prepared by a continuous coating process. The battery may be prepared by conventional processing and construction employing a nickel oxyhydroxide positive electrode, an alkaline electrolyte, and separator. The nickel electrode may be of a sintered type well known in the art or may be of a pasted type employing a foam or felt matrix. In one embodiment, the separator is a polyolefin material. The battery electrolyte may comprise of a KOH solution or alternatively is a NaOH based electrolyte.

An electrode substrate is used as a current conducting and collecting material that houses the active material (iron) of the electrode in a mechanically stable design. Since the resultant iron oxides are not conductive, a conductive substrate is required to maintain electrical contact to the active material. In current pocket electrode designs, the substrate encompasses the active material and holds the material between two layers of conductor, therefore requiring two substrates per electrode. In this process, pockets are formed by interlocking two perforated Ni-coated strips into which the active material is compressed. While such a design offers long life, the energy density is poor.

In the battery of the present invention, a single layer of substrate is used. This single layer acts as a carrier with coated material bonded to at least one side. The substrate may be a thin conductive material such as perforated metal foil or sheet, metal mesh or screen, woven metal, or expanded metal. The substrate may also be a three-dimensional material such as a metal foam or metal felt. In one embodiment, a nickel plated perforated foil has been used.

The coating mixture applied to the substrate is a combination of binder and active materials in an aqueous or organic solution. The mixture can also contain other additives such as pore formers or conductive additives. Conductive additives include but are not limited to carbon, graphite, or Ni powder. Pore formers can be incorporated to enhance electrode porosity and include but are not limited to ammonium carbonate and ammonium bicarbonate. Other additive that may be included in the coating mixture are bismuth, tin, sulfur, and metal sulfides. The binder materials have properties that provide adhesion and bonding between the active material particles, both to themselves and to the substrate current collector. The binder is generally resistant to degradation due to aging, temperature, and caustic environment. The binder can comprise polymers, alcohols, rubbers, and other materials, such as an advanced latex formulation that has been proven effective. A polyvinyl alcohol (PVA) binder is used in one embodiment. Use of a binder to mechanically adhere the active material to the supporting single substrate eliminates the need for expensive sintering or electrochemical post-treatment. Aqueous based solutions have the advantage of lower toxicity and removal of water during the drying process is environmentally friendly and does not require further treatment or capture of the solvent.

The coating method for producing the iron electrode can be a continuous process that applies the active material mixture to the substrate, such as spraying, dip and wipe, extrusion, low pressure coating die, or surface transfer. A batch process may also be used, but a continuous process is advantageous regarding cost and processing. The coating method must maintain a high consistency for weight, thickness, and coating uniformity. This insures that finished electrodes will have similar loadings of active material to provide uniform capacity in the finished battery product.

The coating method of the iron electrode employed in the invented cell is conducive to layering of various materials and providing layers of different properties, such as porosities, densities, and thicknesses. For example, the substrate can be coated with three layers; the first layer being of high density, second layer of medium density, and final layer of a lower density to create a density gradient. This gradient improves the flow of gases from the active material to the electrolyte and provides better electrolyte contact and ionic diffusion with the active material throughout the structure of the electrode.

The active material for the mix formulation is selected from iron species that can be reversibly oxidized and reduced. Such materials include iron metal and iron oxide materials. The iron oxide material will convert to iron metal when a charge is applied. A suitable iron oxide material includes Fe₃O₄. A preferred form of iron is hydrogen reduced with a purity of about 96% or greater and having a 325 mesh size. In addition, other additives may be added to the mix formulation. These additives include but are not limited to sulfur, antimony, selenium, tellurium, bismuth, tin, and metal sulfides.

Sulfur as an additive has been found to be useful in concentrations ranging from 0.25 to 1.5%, and higher concentrations may improve performance even more. Nickel has been used as a conductivity improver and concentrations ranging from 8 to 20% have been found to improve performance, and higher concentrations may improve performance even more.

The iron electrode employed in the invention may include continuous in-line surface treatments. The treatments can apply sulfur, polymer, metal spray, surface laminate, etc. In one embodiment, a polymer post-coat is applied.

The present batteries including the continuous coated iron electrode can be used, for example, in a cellphone, thereby requiring an electrode with only a single side coated. However, both sides are preferably coated, allowing the battery to be used in many applications as is known in the art.

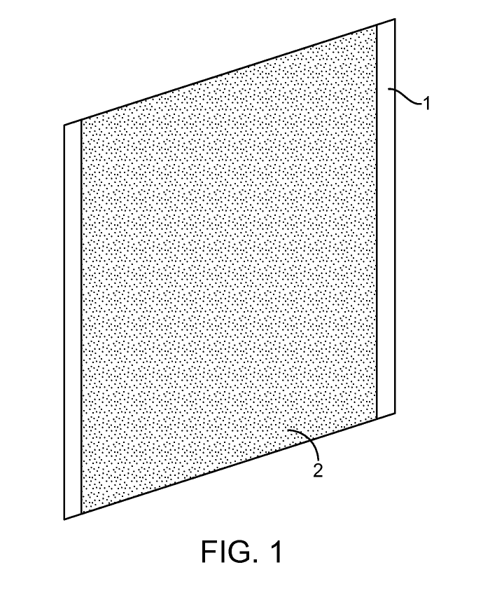

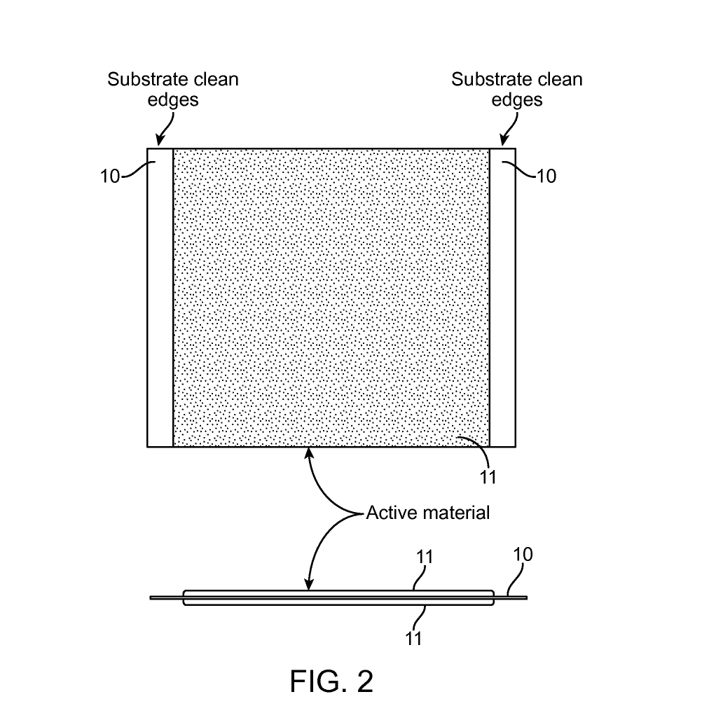

Turning to the figures of the drawing, FIG. 1 is a prospective view of a coated iron electrode. The substrate 1 is coated on each side with the coating 2 comprising the iron active material and binder. This is further shown in FIG. 2. The substrate 1 is coated on each side with the coating 2 of the iron active material and binder. The substrate may be coated continuously across the surface of the substrate, or preferably, as shown in FIGS. 1 and 2, cleared lanes of substrate may be uncoated to simplify subsequent operations such as welding of current collector tabs.

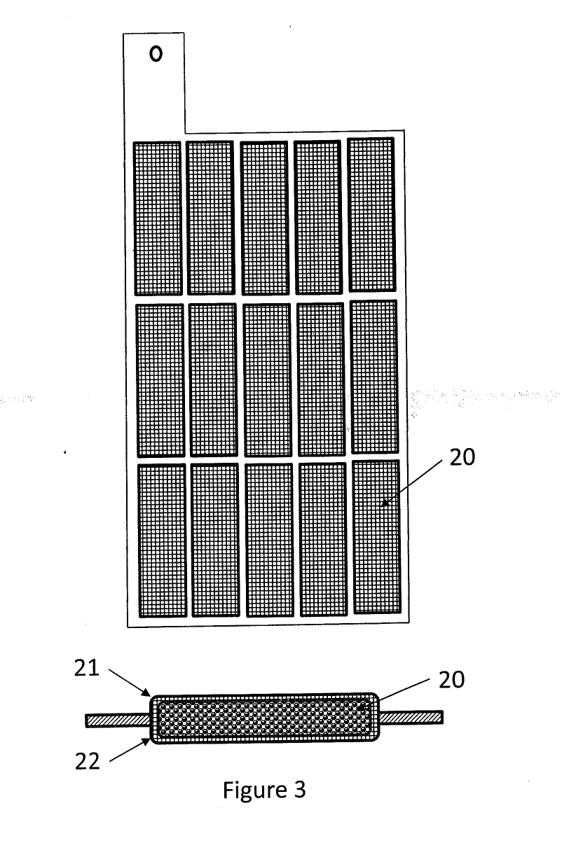

FIG. 3 of shows a conventional pocket iron electrode. The two substrates 21 and 22 are sown to form the pocket which holds the iron active material 20.

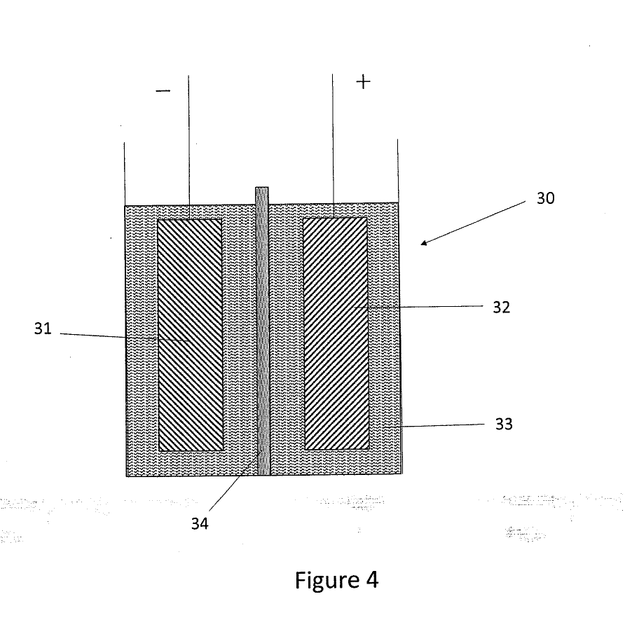

FIG. 4 depicts a battery 30 with an iron anode 31. A cathode 32, such as a nickel or manganese cathode, is also in the battery. The electrolyte 33 surrounds both the iron anode and cathode. The electrolyte is the sodium hydroxide based electrolyte described above, comprising sodium hydroxide, lithium hydroxide and sodium sulfide. The battery separator 34 is in one embodiment an iron-phobic battery separator having a non-polar surface. The battery separator can be made of any substance that provides such a non-polar surface. Polymers are good candidates as they provide smooth and non-polar surfaces. Suitable polymers include the polyolefins.

### ILLUSTRATIVE EXAMPLES

### Paste Preparation

A water based paste comprised of hydrogen reduced iron powder (325 mesh size), 16% nickel powder #255, 0.5% elemental sulfur powder (precipitated, purified) and the appropriate amount of binder was prepared using a digital stirring device and 3-wing stirring blade operating at 1300 RPM for 10-15 minutes. Deionized water was added to the mixture to create a paste with a viscosity between 120,000-130,000 cP.

### Example 1

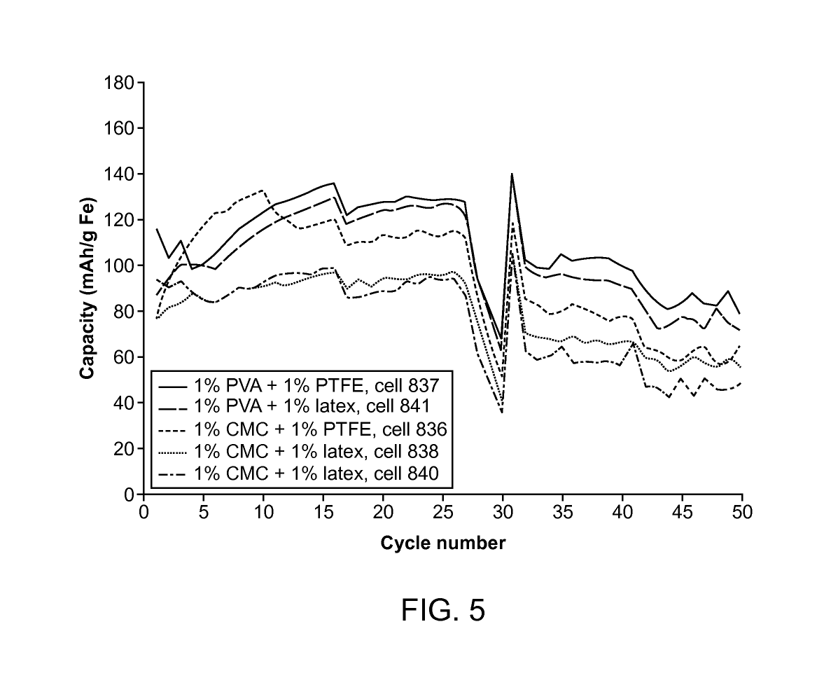

A series of iron electrodes were prepared by impregnating nickel foam with various pastes comprising several different binder compositions described in Table 1. The discharge capacities of the individual cells prepared from these electrodes were measured and plotted against the amount of iron in the anode in FIG. 5. The effect of rate on capacity was evaluated by discharging the cells at multiple rates of C/10, C/5, C/2, and 2C where C represents the current required to discharge the cell in one hour.

TABLE 1

| Cell # | Binder | Binder | g of iron |
|---|---|---|---|
| 1 | 1% CMC | 1% PTFE | 6.4 |
| 2 | 1% PVA | 1% PTFE | 8.5 |
| 3 | 1% CMC | 1% AL-2002 latex | 7.9 |
| 4 | 1% CMC | 1% AL-3001 latex | 7.4 |
| 5 | 1% PVA | 1% AL-1002 latex | 8.3 |

Since the binder can contribute to electrode resistance, it is desirable to employ a binder that minimizes an increase in cell resistance and offers the highest mAh/g capacity. Comparing the 2C rate discharge capacities of the Ni—Fe batteries, the best results at 2C discharge rate were obtained in cells employing PVA as a binder.

### Example 2

Water based pastes (Table 2) were applied to a 1.63″ wide nickel-plated perforated strip with 2-mm perforations by feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° C. for 20 minutes.

TABLE 2

| | PVA concentration | Iron in electrode | Capacity |
|---|---|---|---|
| Sample | (%) | (g) | (mAh/g Fe) |
| 1 | 3.5 | 8.3 | 117 |
| 2 | 3.5 | 8.45 | 116 |
| 3 | 3.5 | 11.4 | 112 |
| 4 | 5 | 8.25 | 89 |
| 5 | 7 | 10.1 | 69 |
| 6 | 9 | 8.55 | 8 |

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

A series of continuously coated iron electrodes were prepared by coating perforated NPS with an aqueous mixture of iron powder, nickel powder as a conductivity aid, elemental sulfur and employing PVA as a binder. Multiple levels of PVA were employed in the mixes to evaluate the effect of binder concentration on mechanical stability of the electrode and rate capability of the electrode. At concentrations below 3 weight percent PVA, the physical integrity of the electrodes was unacceptable. Concentrations of binder above about 5 weight percent showed a sharp drop in discharge capacity, most likely due to increased electrode resistance and possibly masking of the active material from the electrolyte interface. Data for cells with varying levels of PVA is summarized in Table 2.

### Example 3

A 10 wt % solution of PVA (Elvanol 7130) preheated to between 120-125° F. was added to a jacketed container with iron powder (325 mesh), nickel powder #255, and sulfur preheated to 120° F. This mixture was stirred for 30 minutes at 120° F. The solid component mixture of this paste was 80% iron, 16% nickel, 0.4% sulfur, and 3.5% PVA. Viscosity measurements of the paste had a range of 25000 to 39000 cP immediately after removal from the container and after a further 90 seconds, the viscosity ranged from 22000 to 31000 cP.

The paste mixture was then transferred to a jacketed holding tank preheated to 110° F. where it was stirred. The paste was pumped to a paste hopper where a perforated nickel plated steel strip was coated. The coated strip was then passed through a doctor blade to achieve a coating thickness between 0.040-0.050″ and introduced to a vertical drying oven. The first stage of drying consisted of IR heating at 240° F. for 1.67 minutes followed by heating in a conventional oven at 240° F. for 3.35 minutes. The second drying stage with a residence time of 1.7 minutes consisted of forced hot air with a set drying temperature of 260° F. The paste temperature exiting the ovens did not exceed 210° F. After cooling, the finished coating was calendared to a thickness of 0.025″. Pieces of the coating were cut to size and weighed to obtain coating porosity. The porosity ranged from 34-43% with a targeted porosity of 38%.

Negative electrodes from Example 3 were used to construct a Ni—Fe battery. Table 3 shows the performance of the Ni—Fe battery of the present invention in comparison to other commercial Ni—Fe batteries employing pocket plate electrodes.

TABLE 3

| | | Seiden | Seiden | | | Ni—Fe cell |
|---|---|---|---|---|---|---|
| | | TV200 | TV10 | Zapp | Eagle | of present |
| Battery | Taihang | (2) | (2) | Works | Picher | invention |
| Specific | 15.47 | 23.10 | 18.12 | 7.55 | 8.73 | 28 |
| Energy | | | | | | |
| (WH/kg) | | | | | | |
| Specific | 30.94 | 46.19 | 36.24 | 15.10 | 17.45 | 170 |
| Power | | | | | | |
| (W/kg) | | | | | | |
| Energy | 25.42 | 43.39 | 30.39 | 14.79 | 21.39 | 67 |
| Density | | | | | | |
| (WH/L) | | | | | | |
| Power | 50.84 | 86.78 | 60.79 | 29.58 | 42.77 | 407 |
| Density | | | | | | |
| (W/L) | | | | | | |
| Type of | Pocket | Pocket | Pocket | Pocket | Pocket | Continuous |
| iron | plate | plate | plate | plate | plate | coated |
| electrode | | | | | | (Pasted) |

### Example 4

### Paste Preparation

A water based paste comprised of hydrogen reduced iron powder (325 mesh size), nickel powder #255, elemental sulfur powder (precipitated, purified) and the appropriate amount of binder was prepared using a digital stirring device and 3-wing stirring blade operating at 1300 RPM for 10-15 minutes. Deionized water was added to the mixture to create a paste with a viscosity between 120,000-130,000 cP. The nickel and iron content was varied according to Table 3, the sulfur content was 0.5%, and the binder content was 3.5%.

Water based pastes with varying nickel and iron content (Table 4) were applied to a 1.63″ wide nickel-plated perforated strip with 2-mm perforations by feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° C. for 20 minutes.

TABLE 4

| Sample | Nickel (%) | Iron % |
|---|---|---|
| 1 | 8 | 88 |
| 2 | 12 | 84 |
| 3 | 16 | 80 |
| 4 | 20 | 76 |

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

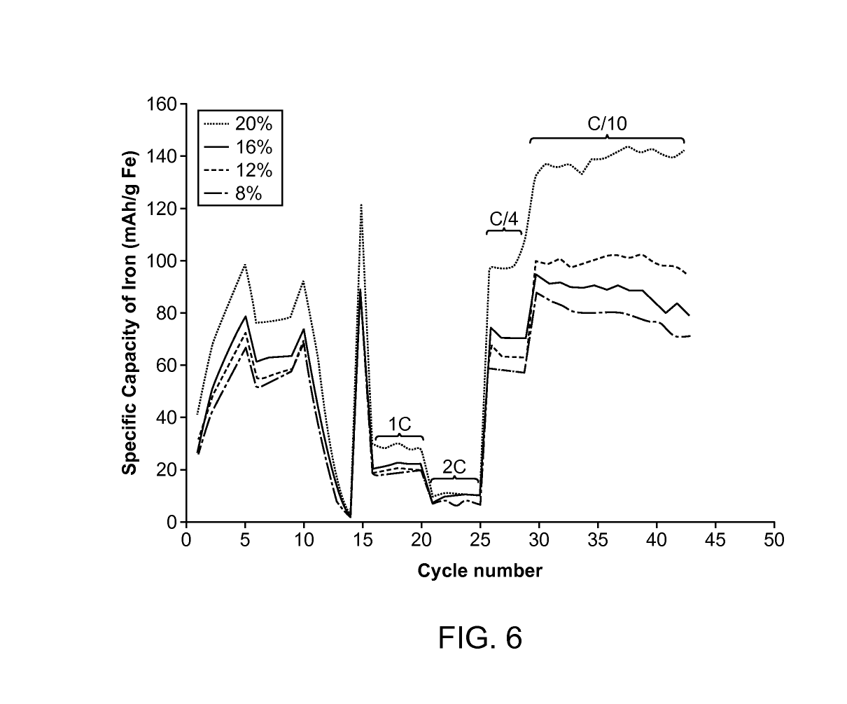

Ni—Fe cells were constructed using electrodes fabricated from the pastes with varying nickel and iron content. The data is shown in FIG. 6. The cell performance does not appear to be very dependent upon nickel concentration in the concentration range between 8-16% but improved capacity at high (1 C) and low rates (C/10) is observed for electrodes with 20% nickel.

### Example 5

### Paste Preparation

A water based paste comprised of hydrogen reduced iron powder (325 mesh size), nickel powder #255, elemental sulfur powder (precipitated, purified) and the appropriate amount of binder was prepared using a digital stirring device and 3-wing stirring blade operating at 1300 RPM for 10-15 minutes. Deionized water was added to the mixture to create a paste with a viscosity between 120,000-130,000 cP. The nickel content was 16%, polyvinyl alcohol 3.5%, and the sulfur content was varied between 0 and 1.5% with the remainder of the electrode composition being iron powder.

Water based pastes with varying sulfur content were applied to a 1.63″ wide nickel-plated perforated strip with 2-mm perforations by feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° C. for 20 minutes.

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

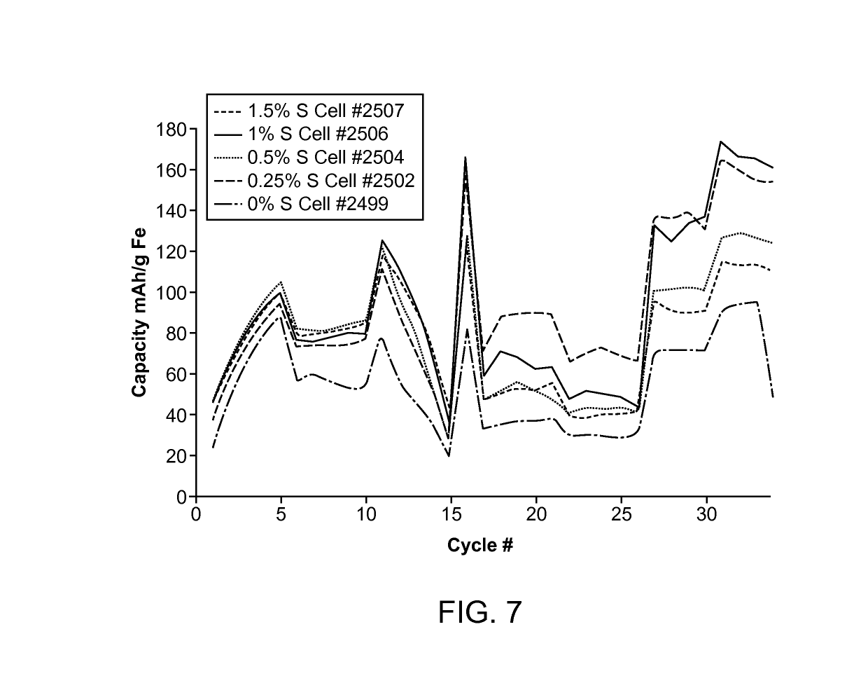

Ni—Fe cells were constructed using electrodes fabricated from the pastes with varying sulfur content. The data is shown in FIG. 7. Increasing the sulfur content of the electrode increases the capacity at the C/10 discharge rate until the sulfur content reaches about 1.5% where there is no further increase in capacity. Increasing the sulfur content increased the capacity of the iron electrode even at sulfur contents up to 1.5% at the 1 C and 2C discharge rates.

In the foregoing examples, the invention Ni—Fe battery used an electrolyte comprised of sodium hydroxide (NaOH), lithium hydroxide (LiOH), and sodium sulfide (Na₂S). The separator used in the inventive Ni—Fe battery was a 0.010 inch thick polyolefin non-woven mesh. A sintered nickel electrode impregnated with nickel hydroxide was used as the positive electrode in the battery of the present invention. The electrolyte used in the conventional Ni—Fe batteries was potassium hydroxide (KOH), and the anode and cathode were kept electrically isolated using a spacer. The results show a vast improvement in performance characteristics for the inventive Ni—Fe battery.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A Ni—Fe battery comprising an iron anode comprised of a single conductive substrate coated on one or both sides with an iron active material.

2. The Ni—Fe battery of claim 1, wherein the iron anode comprises a polyvinyl alcohol (PVA) binder.

3. The Ni—Fe battery of claim 2, wherein the amount of PVA binder in the iron anode is in the range of from 2.5 to 4. wt %.

4. The Ni—Fe battery of claim 1, wherein the iron active material comprise Fe metal.

5. The Ni—Fe battery of claim 1, wherein the iron active material comprises Fe₃O₄.

6. The Ni—Fe battery of claim 1, wherein the iron anode further comprises an additive.

7. The Ni—Fe battery of claim 6, wherein the additive comprises nickel powder.

8. The Ni—Fe battery of claim 6, wherein the additive comprises sulfur.

9. The Ni—Fe battery of claim 8, wherein the sulfur comprises elemental sulfur.

10. The Ni—Fe battery of claim 8, wherein the sulfur comprises a sulfide.

11. The Ni—Fe battery of claim 1, wherein the iron anode comprises layers of materials having different properties.

12. The Ni—Fe battery of claim 11, wherein the layers have different porosities or densities.

13. The Ni—Fe battery of claim 11, wherein the layers have different concentrations of additives.

14. The Ni—Fe battery of claim 1, wherein the iron anode is prepared by a continuous process.

15. The Ni—Fe battery of claim 14, wherein the continuous process comprises continuously coating a continuous substrate material on at least one side with a mix formulation comprising an active iron material and a binder.

16. The Ni—Fe battery of claim 15, wherein the mix formulation further comprises sulfur.

17. The Ni—Fe battery of claim 16, wherein the sulfur in the mix formulation comprises elemental sulfur.

18. The Ni—Fe battery of claim 16, wherein the mix formulation comprises a sulfide.

19. The Ni—Fe battery of claim 15, wherein the binder comprises PVA.
